(19) United States
(12) Patent Application Publication
(10) Pub. No.: US 2008/0309445 A1
(43) Pub. Date: Dec. 18, 2008

(54) TRANSFORMER

(75) Inventors: Katsuyuki SUZUKI, Tokyo (JP); Hiroshi Suzuki, Tokyo (JP)

Correspondence Address: YOUNG LAW FIRM, P.C.;ALAN W. YOUNG, 4370 ALPINE ROAD, SUITE 106, PORTOLA VALLEY, CA, 94028, US

(73) Assignee: TDK Corporation, Tokyo (JP)

(21) Appl. No.: 12/138,350

(22) Filed: Jun. 12, 2008

(30) Foreign Application Priority Data
Jun. 14, 2007 (JP) 2007157484
May 23, 2008 (JP) 2008135236

(51) Int. Cl. H01F 27/28

(52) U.S. Cl. 336/183

(57) ABSTRACT

A transformer is provided with first and second windings that constitute a primary winding, third and fourth windings that constitute a secondary winding, and a magnetic core on which the first through fourth windings are wound. A first distance in a radial direction of a wire between the first winding and the third winding, a second distance in the radial direction of the wire between the first winding and the fourth winding, a third distance in the radial direction of the wire between the second winding and the third winding, and a fourth distance in the radial direction of the wire between the second winding and the fourth winding are substantially equal in the same turn.

### CROSS REFERENCE TO RELATED APPLICATIONS

This application claims the foreign priority under 35 U.S.C. §119(a)-(d) of Japanese Patent Application No. 2007-157484, filed Jun. 14, 2007, and Japanese Patent Application No. 2008-135236, filed May 23, 2008, which applications are hereby incorporated herein by reference in their entireties.

### TECHNICAL FIELD

The present invention relates to a transformer, such as a pulse transformer and the like, and more particularly relates to a winding structure of a transformer.

### BACKGROUND OF THE INVENTION

There is an accelerating trend toward higher speed and greater capacity in communications on the Internet, local area networks (LAN), and other communication fields. In the background of this trend is development of a broad array of new transmission systems and ICs (integrated circuits) in conjunction with the digitalization of transmission signals. Among these developments, one indispensable electronic device is the pulse transformer (broadband transmission transformer) for use in communications, and there is a need for characteristics that accommodate the rapid progress of communications technologies.

FIG. 17 is a schematic perspective external view showing an example of the configuration of a conventional pulse transformer 500 (see Japanese Laid-open Patent Application No. 7-161535).

The pulse transformer 500 has a structure in which a primary winding 42 and a secondary winding 43 are wound on a toroidal core 41, as shown in FIG. 17. The primary winding 42 is composed of first and second windings 11, 12. One end 11a of the first winding 11 constitutes one of the input terminals of the primary winding 42, the other end 11b of the first winding 11 and one end 12a of the second winding 12 are connected to form the center point of the primary winding 42, and the other end 12b of the second winding 12 constitutes the other input terminal of the primary winding 42. Furthermore, the secondary winding 43 is composed of third and fourth windings 13, 14. One end 13a of the third winding 13 constitutes one of the output terminals of the secondary winding 43, the other end 13b of the third winding 13 and one end 14a of the fourth winding 14 are connected to form the center point of the secondary winding 43, and the other end 14b of the fourth winding 14 constitutes the other output terminal of the secondary winding 43.

However, there is a problem in that winding procedures on the toroidal core 41 are very cumbersome and are difficult to automate. There is also a problem in that characteristics are nonuniform and reliability is reduced due to the complex wiring configuration resulting from connecting windings to each other. Yet another problem is that product miniaturization is difficult because of the complex wiring configuration.

On the other hand, drum cores are known as magnetic cores in which winding procedures are simple (e.g., Japanese Laid-open Patent Application No. 2003-100531). However, even if a drum core is used, there are occasions when an electromagnetic coupling between windings is insufficient depending on the winding method, and good frequency characteristics cannot be obtained.

As described above, there is also a need for rapid progress in pulse transformers in conjunction with higher speed and greater capacity in communications. It is preferable that a pulse transformer have advantageous characteristics for broadband transmission of signals and an ability to sufficiently block common mode noise. In order to accomplish this, frequency characteristics must be improved and high-frequency digital signal waveforms must be made highly reproducible.

### SUMMARY OF THE INVENTION

It is therefore an object of the present invention to provide a transformer having a good efficiency of magnetic coupling between windings and advantageous frequency characteristics.

The present inventors, as a result of thorough-going research into solving the above problems, discovered that the positional relationship of each winding in the same turn influences frequency characteristics of the transformer. The present invention is based on this technical finding.

In other words, the above object of the present invention can be accomplished by a transformer comprising first and second windings that constitute a primary winding, third and fourth windings that constitute a secondary winding, and a magnetic core on which the first through fourth windings are wound, wherein a first distance in the radial direction of the wire between the first winding and the third winding, a second distance in the radial direction of the wire between the first winding and the fourth winding, a third distance in the radial direction of the wire between the second winding and the third winding, and a fourth distance in the radial direction of the wire between the second winding and the fourth winding are substantially equal in the same turn.

According to the present invention, a stronger magnetic coupling is made possible in a part that has virtually no phase shift in a flowing signal because the distance is uniform between the primary winding and the secondary winding in the same turn. Frequency characteristics of the transformer can thereby be improved.

It is preferable in the present invention that the first winding and third winding are in contact, the first winding and the fourth winding are in contact, the second winding and third winding are in contact, and the second winding and the fourth winding are in contact in the same turn. In this way, the distance between the primary winding and the secondary winding can be minimized in the same turn. A better magnetic coupling can be obtained thereby.

It is preferable in the present invention that a fifth distance in the radial direction of the wire between the first winding and the second winding in the same turn is longer than the first distance in the radial direction of the wire between the first winding and the third winding in the same turn. In this case, a fifth distance in the radial direction of the wire between the first winding and the second winding in the same turn may be substantially equal to a sixth distance in the radial direction of the wire between the third winding and the fourth winding in the same turn. Alternatively, the distance in the radial direction of the wire between the first winding and the second winding in the same turn may be substantially equal to the distance in the radial direction of the wire of the third winding and the fourth winding in the same turn. The former instance has the benefit that the winding procedure is simplified, and the latter instance has the benefit that the magnetic coupling balance becomes more uniform.

It is preferable in the present invention that the first through fourth windings have the same number of turns, a connecting point between the first winding and the second winding constitute a center point of the primary winding, and a connecting point between the third winding and the fourth winding constitute a center point of the secondary winding. It is also preferable that in the second turn and thereafter, the first winding make contact with the fourth winding of the previous turn, and the third winding make contact with the second winding of the previous turn.

It is preferable that the transformer of the present invention comprise two winding layers including a first and second winding layer, wherein the first winding layer comprises a bifilar winding between the first winding and the fourth winding, and the second winding layer comprises a bifilar winding between the third winding and the second winding. According to this configuration, it is possible to realize a transformer in which variability in the length of the windings can be reduced and variability in inductance is low.

It is also preferable that the transformer of the present invention comprise two winding layers including the first and second winding layers, wherein the first and fourth windings are wound in a bifilar winding in the first winding layer, and the third and second windings are wound in a bifilar winding in the second winding layer in a region that is half of the winding core of the magnetic core, and the second and third windings are wound in a bifilar winding in the first winding layer, and the fourth and first windings are wound in a bifilar winding in the second winding layer in a region that is a remaining half of the winding core. The length of the winding in the external peripheral side is longer than that of the winding in the internal peripheral side. According to this configuration, it is possible to realize a transformer in which variability in the length of the windings can be reduced and variability in inductance is low.

It is preferable that the transformer of the present invention further comprise a first and a second wiring pattern that is formed on a printed circuit board on which the magnetic core is mounted. Further, the first winding and the second winding are connected via the first wiring pattern on the printed circuit board, and the third winding and the fourth winding are connected via the second wiring pattern on the printed circuit board. According to this configuration, a procedure for connecting wire members beforehand becomes unnecessary, and it is possible to facilitate winding procedures because the terminal members of the coil constituting the transformer are connected via the connection conductor pattern by merely having the transformer be mounted on the circuit board. Moreover, variability in characteristics, lower reliability, and other problems can be solved, and product miniaturization also becomes possible because wiring conditions are simplified.

It is preferable that the transformer of the present invention further comprise a resin cover for accommodating the drum core, wherein the first through fourth windings are wound around the drum core via the resin cover. In this case, it is particularly preferable that corners of the resin cover that are in contact with any of the first through fourth windings are chamfered. When the drum core is accommodated in the resin cover, it is possible to form terminal electrode pairs for the windings on the bottom surface of the resin cover. Accordingly, it becomes unnecessary to form terminal electrodes on the drum core, and an insulating coating on the drum core also becomes unnecessary. It is possible to put the windings into a constant, optimally taut state and to form a state in which the windings are less likely to become displaced, because the plate-spring properties of the resin cover will operate on the windings. Furthermore, a resin cover is easy to chamfer, and it is possible to prevent winding damage by chamfering the angles of the resin cover.

In this manner, the transformer of the present invention makes it possible to improve electromagnetic coupling efficiency between the windings, and to assure improvement in frequency characteristics, because the distances of the primary and secondary windings are equal in the same turn.

### BRIEF DESCRIPTION OF THE DRAWINGS

The above and other objects, features and advantages of this invention will become more apparent by reference to the following detailed description of the invention taken in conjunction with the accompanying drawings, wherein:

FIG. 1 is a schematic perspective view showing the external structure of a transformer 100 according to a preferred first embodiment of the present invention;

FIG. 2 is a schematic bottom plan view showing the structure of the bottom surface of the transformer 100;

FIG. 3 is an equivalent circuit diagram of the transformer 100 mounted on a printed circuit board 30;

FIG. 4 is a schematic cross-sectional view showing wrapping structure details of the transformer 100;

FIG. 5 is an enlarged schematic view of the same turn portion X;

FIG. 6 is a schematic cross-sectional view showing a winding structure of a transformer 600 according to a comparative example;

FIG. 7 is an enlarged schematic view of the same turn portion X;

FIG. 8 is a schematic cross-sectional view showing a winding structure of a transformer 200 according to a second embodiment of the present invention;

FIG. 9 is an enlarged schematic view of the same turn portion X;

FIG. 10 is a schematic cross-sectional view showing a winding structure of a transformer 300 according to a third embodiment of the present invention;

FIG. 11 is a schematic cross-sectional view showing details of a winding structure of a transformer 400 according to a fourth embodiment of the present invention;

FIG. 12 is a schematic perspective view showing an external appearance of a structure of a transformer 700 according to a fifth embodiment of the present invention;

FIG. 13 is an exploded perspective view of the transformer 700;

FIG. 14 is a cross-sectional view of the transformer along the line A-A of FIG. 12;

FIG. 15 is a graph showing the insertion loss (signal attenuation characteristics) of the transformer;

FIG. 16 is a graph showing common-mode noise attenuation characteristics of the transformer; and

FIG. 17 is a schematic perspective external view showing an example of the configuration of a conventional pulse transformer 500.

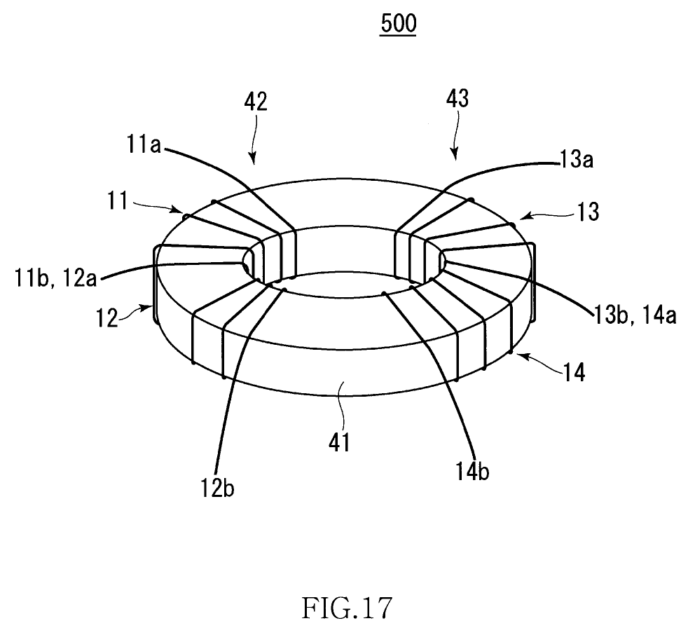

### DESCRIPTION OF THE PREFERRED EMBODIMENTS

Preferred embodiments of the present invention will now be described in detail hereinafter with reference to the accompanying drawings.

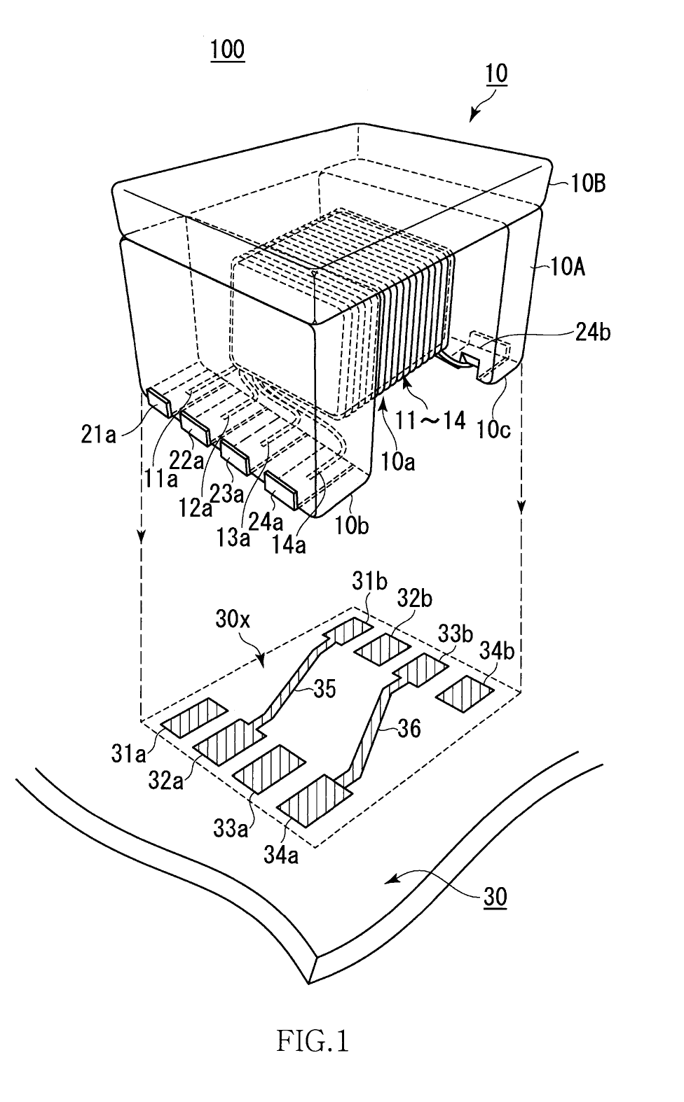

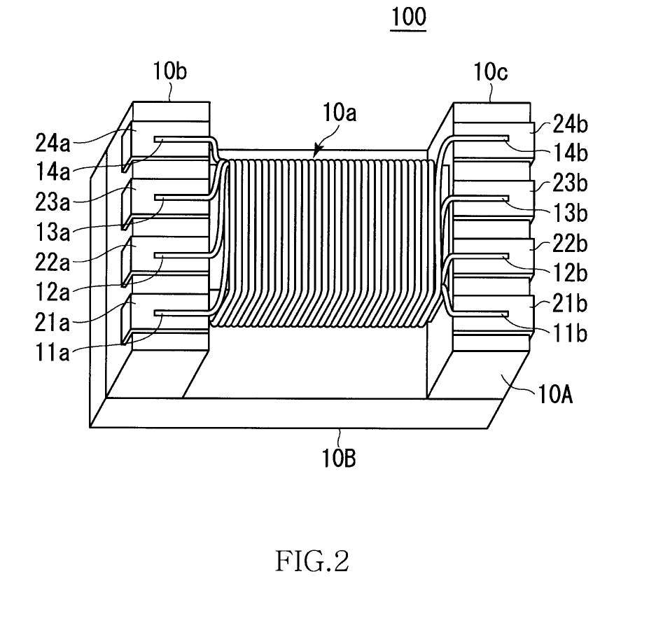

FIG. 1 is a schematic perspective view showing the external structure of a transformer 100 according to a preferred first embodiment of the present invention. FIG. 2 is a schematic bottom plan view showing the structure of the bottom surface of the transformer 100.

As shown in FIGS. 1 and 2, the transformer 100 is provided with a magnetic core 10 having a bar-shaped winding core 10a and first through fourth windings 11 through 14 that are wound on the magnetic core 10. The first through fourth windings 11 through 14 have the same number of turns.

The magnetic core 10 of the present embodiment is composed of a drum core 10A, and a plate core 10B that is mounted on an upper part of the drum core 10A. The drum core 10A is provided with the bar-shaped winding core 10a, and flanges 10b, 10c that are provided to the two end portions, respectively, of the winding core 10a, and these parts have an integrated structure. The plate core 10B is a separate entity from the drum core 10A, and is secured to the upper surfaces of the flanges 10b, 10c. In this way, the drum core 10A and the plate core 10B constitute a closed magnetic circuit. Although it is not particularly limited, the material for the magnetic core 10 can be a Mn—Zn ferrite. It is preferable that a paraxylylene or other insulating coating be applied to the surface of the magnetic core 10.

First through fourth terminal electrode pairs 21a, 21b through 24a, 24b are formed on bottom surfaces of the flanges 10b, 10c of the drum core 10A. The two end portions 11a, 11b of the first winding 11 are connected to the first terminal electrodes 21a, 21b, respectively. The two end portions 12a, 12b of the second winding 12 are connected to the second terminal electrodes 22a, 22b, respectively. The two end portions 13a, 13b of the third winding 13 are connected to the third terminal electrodes 23a, 23b, respectively. The two end portions 14a, 14b of the fourth winding 14 are connected to the fourth terminal electrodes 24a, 24b, respectively.

On the other hand, a mounting area 30X of the transformer 100 is provided on a printed circuit board 30, and first through fourth land pattern pairs 31a, 31b through 34a, 34b are provided inside the mounting area 30X of the transformer 100. The first through fourth land pattern pairs 31a, 31b through 34a, 34b correspond to the first through fourth terminal electrode pairs 21a, 21b through 24a, 24b, respectively. Furthermore, first and second conductive patterns 35, 36 are formed inside the mounting area 30X for the transformer 100. The first conductive pattern 35 short-circuits the land pattern 31b and the land pattern 32a, and the second conductive pattern short-circuits the land pattern 33b and the land pattern 34a. When the transformer 100 is mounted, the end portions of the first winding 11 and the second winding 12 are connected to each other via the first connective pattern 35, and the end portions of the third winding 13 and the fourth winding 14 are connected to each other via the second connective pattern 36.

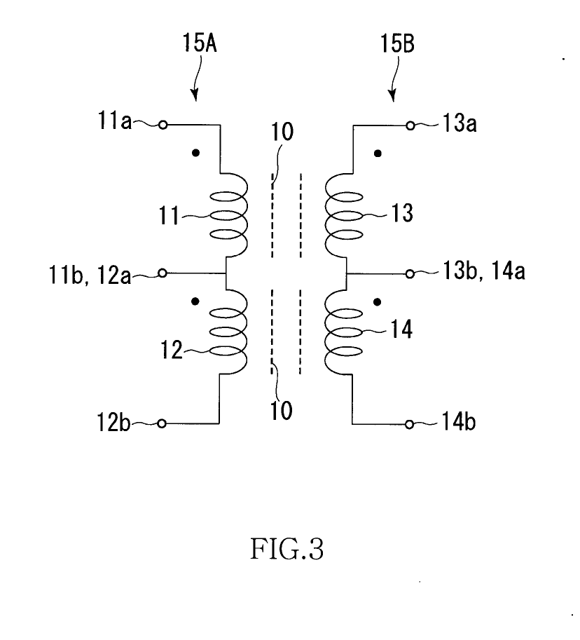

FIG. 3 is an equivalent circuit diagram of the transformer 100 mounted on a printed circuit board 30.

Among the first through fourth windings 11 through 14 that are wound on the winding core 10a of the magnetic core 10, the first and second windings 11, 12 constitute the primary winding 15A of the transformer 100, and the third and fourth windings 13, 14 constitute the secondary winding 15B of the transformer 100, as shown in FIG. 3. One end 11a of the first winding 11 constitutes one of the terminals of the primary winding 15A, the other end 11b of the first winding 11 is connected to one end 12a of the second winding 12 to form the center point of the primary winding 15A, and the other end 12b of the second winding 12 constitutes the other terminal of the primary winding 15A. One end 13a of the third winding 13 constitutes one of the terminals of the secondary winding 15B, the other end 13b of the third winding 13 is connected to one end 14a of the fourth winding 14 to form the center point of the secondary winding 15B, and the other end 14b of the fourth winding 14 constitutes the other terminal of the secondary winding 15B.

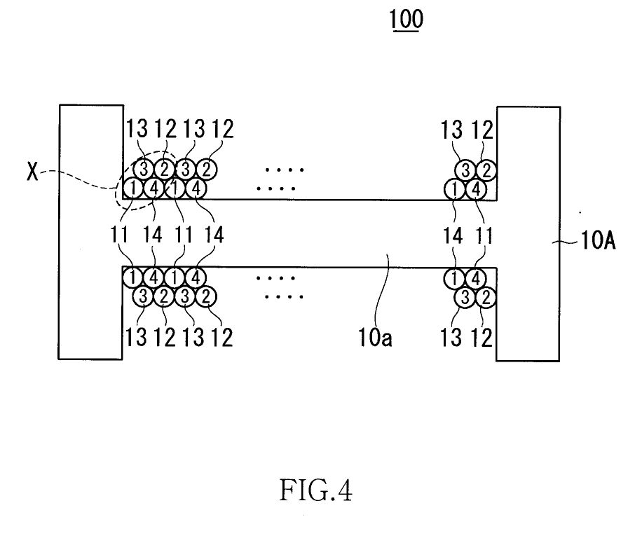

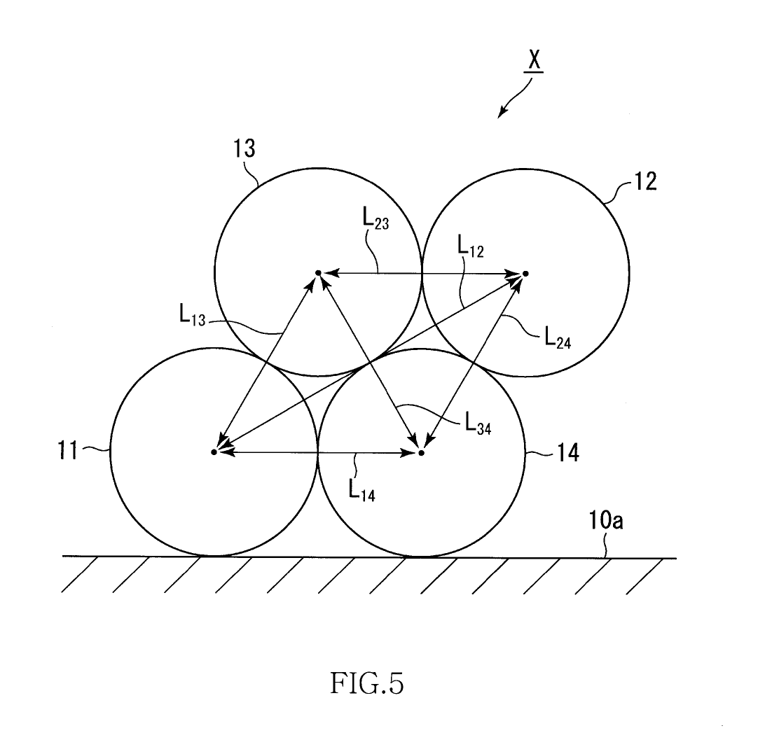

FIG. 4 is a schematic cross-sectional view showing wrapping structure details of the transformer 100, and FIG. 5 is an enlarged schematic view of the same turn portion X.

As shown in FIG. 4, the first through fourth windings 11 through 14 are wound on the winding core 10a of the magnetic core 10, and these windings have a two-layer structure. The first and the fourth windings 11, 14 are wound in a single-layer array on the winding core 10a of the magnetic core 10, and constitute the first winding layer. The third and the second windings 13, 12 are wound in a single-layer array on the first winding layer, and constitute the second winding layer. In other words, the first and fourth windings 11, 14 are wound in a bifilar winding in the first layer (internal peripheral side), and the third and second windings 13, 12 are wound in a bifilar winding in the second layer (external peripheral side). A bifilar winding refers to a wire winding method for improving the electromagnetic coupling between windings by winding two windings together.

As shown in FIGS. 4 and 5, the first through fourth windings 11 through 14 in the same turn have a positional relationship wherein the first winding 11 is in contact with the third and fourth windings 13, 14, and the second winding 12 is in contact with the third and fourth windings 13, 14. The distance L₁₃ in the radial direction of the wire between the first winding 11 and the third winding 13, the distance L₁₄ in the radial direction of the wire between the first winding 11 and the fourth winding 14, the distance L₂₃ in the radial direction of the wire between the second winding 12 and the third winding 13, and the distance L₂₄ in the radial direction of the wire between the second winding 12 and the fourth winding 14 are thereby substantially equal in the same turn. As used herein, the phrase “distance of the winding” refers to a distance in which the center portions of the windings are used as a reference, as shown in FIG. 5.

In the present embodiment, the position in the radial direction of the wire of the third and second windings 13, 12 are offset by a half pitch from the first and fourth windings 11, 14, because the second layer windings 13, 12 are disposed so as to fit into depressions that are formed between the first layer windings 11, 14. Therefore, the first winding 11 and the second winding 12 are not in contact in the same turn, the distance L₁₂ in the radial direction of the wire between the first winding 11 and the second winding 12 is longer than the distance L₃₄ in the radial direction of the wire between the third winding 13 and the fourth winding 14 in the same turn. On the other hand, the third winding 13 and the fourth winding 14 are in contact in the same turn, and the distance L₃₄ in the radial direction of the wire between the third winding 13 and the fourth winding 14 is equal to the aforedescribed distances L₁₃, L₁₄, L₂₃, L₂₄

In this manner, in accordance with the transformer 100 of the present embodiment, the distances L₁₃, L₁₄, L₂₃, L₂₄ between the primary winding and the secondary winding are substantially equal in the same turn, and since the primary and secondary windings are in contact in the same turn, an improvement of electromagnetic coupling efficiency of the windings is made possible and frequency characteristics of the transformer can be improved. Moreover, the winding procedure can be simplified because the second layer windings 13, 12 can be wound using the depressions that are formed between the first layer windings 11, 14 as a guide.

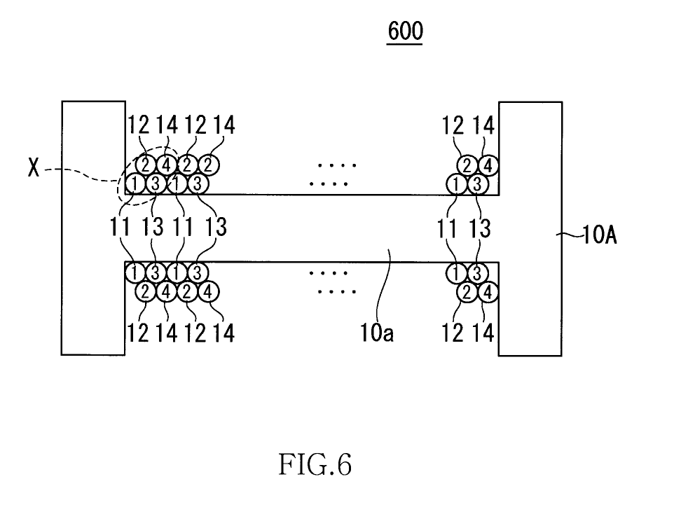

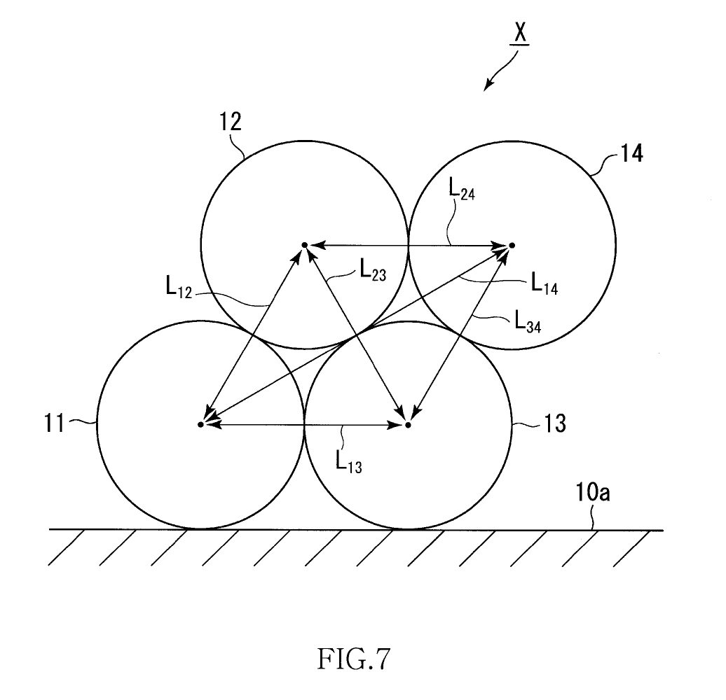

FIG. 6 is a schematic cross-sectional view showing a winding structure of a transformer 600 according to a comparative example. FIG. 7 is an enlarged schematic view of the same turn portion X. In the example shown in FIGS. 6 and 7, the pair of windings composed of the first and the third windings 11, 13 constitute the first layer, and the pair of windings composed of the second and the fourth windings 12, 14 constitutes the second layer.

The distances L₁₃, L₂₃, L₂₄ are substantially equal between the primary winding and the secondary winding in the same turn, but the distance L₁₄ is longer than the other distances in the example shown in FIGS. 6 and 7. In other words, the distance between the primary winding and the secondary winding in the same turn is partially nonuniform, and a slight unbalance occurs in the electromagnetic coupling.

In contrast to the example, with the transformer 100 according to the present embodiment, stronger electromagnetic coupling can be obtained, and improved frequency characteristics can be obtained because the distances L₁₃, L₁₄, L₂₃, L₂₄ are substantially equal between the primary winding and the secondary winding in the same turn, as described above.

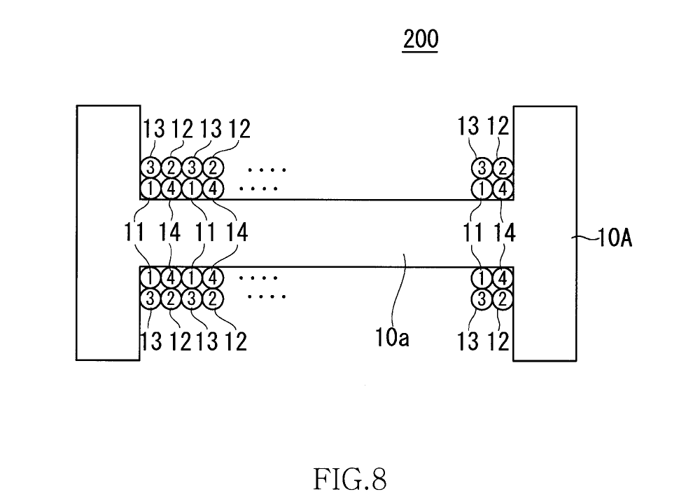

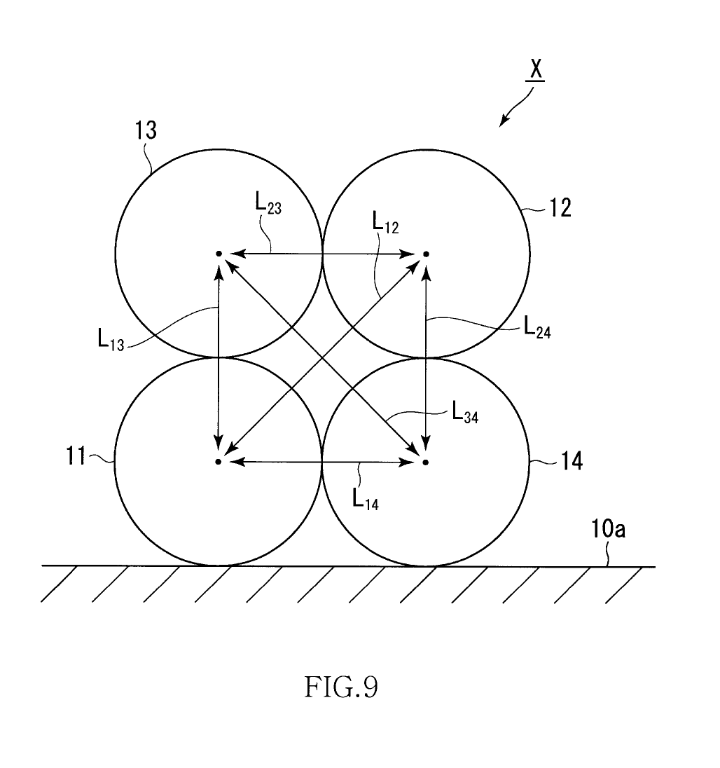

FIG. 8 is a schematic cross-sectional view showing a winding structure of a transformer 200 according to a second embodiment of the present invention. FIG. 9 is an enlarged schematic view of the same turn portion X.

As shown in FIGS. 8 and 9, the transformer 200 has a winding structure wherein the third and second windings 13, 12 provided in the second layer are disposed directly above the first and fourth windings 11, 14, respectively, provided in the first layer. Accordingly, the first winding 11 is in contact with the third and fourth windings 13, 14, and the second winding 12 is in contact with the third and fourth windings 13, 14 in the same manner as the transformer 100 according to the first embodiment. The distance L₁₃ in the radial direction of the wire between the first winding 11 and the third winding 13, the distance L₁₄ in the radial direction of the wire between the first winding 11 and the fourth winding 14, the distance L₂₃ in the radial direction of the wire between the second winding 12 and the third winding 13, and the distance L₂₄ in the radial direction of the wire between the second winding 12 and the fourth winding 14 are substantially equal in the same turn.

On the other hand, in the transformer 200, the first winding 11 and the second winding 12 are not in contact, and the third winding 13 and the fourth winding 14 are not in contact. For this reason, the distance L₁₂ in the radial direction of the wire between the first winding 11 and the second winding 12, and the distance L₃₄ in the radial direction of the wire between the third winding 13 and the fourth winding 14 in the same turn are equal to each other, and both the distances L₁₂ and L₃₄ are longer than the aforedescribed distances L₁₃, L₁₄, L₂₃, L₂₄

In this manner, not only the distances L₁₃, L₁₄, L₂₃, L₂₄ between the primary winding and the secondary winding are equal to each other in the transformer 200 according to the present embodiment, but the distance L₁₂ between the primary windings and the distance L₃₄ between the secondary windings are also equal to each other. For this reason, the electromagnetic coupling balance can be made more uniform in comparison to the transformer 100 according to the first embodiment.

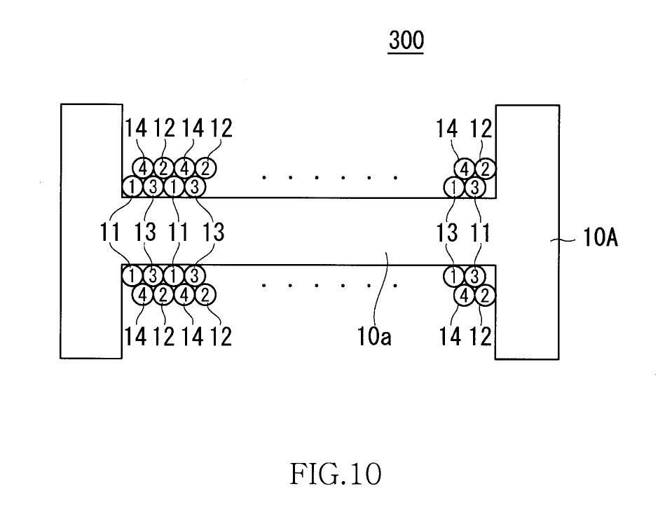

FIG. 10 is a schematic cross-sectional view showing a winding structure of a transformer 300 according to a third embodiment of the present invention.

The transformer 300 features a configuration in which the position of the fourth winding 14 of the transformer 100 shown in FIG. 4 is exchanged with the position of the third winding 13, as shown in FIG. 10. In other words, transformer 300 has a winding structure wherein the first winding 11 and the third winding 13 are wound in a bifilar winding in the first layer, and the fourth winding 14 and second winding 12 are wound in a bifilar winding in the second layer. Since other configurations are the same as the first embodiment, the same reference numerals are used for the same constituent elements, and a description thereof is omitted.

According to the present embodiment, strong electromagnetic coupling can be obtained and frequency characteristics can be improved in the same manner as the transformer 100 because the distances L₁₃, L₁₄, L₂₃, L₂₄ are substantially equal between the primary winding and the secondary winding in the same turn.

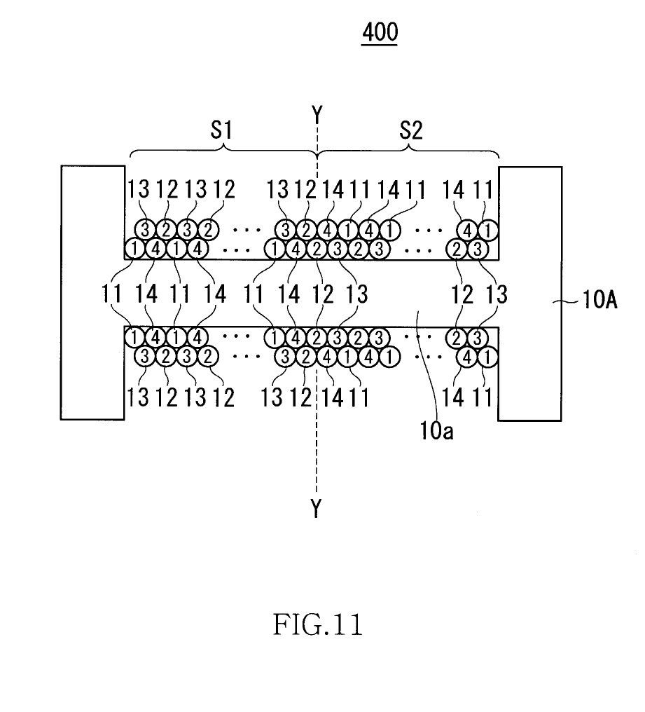

FIG. 11 is a schematic cross-sectional view showing details of a winding structure of a transformer 400 according to a fourth embodiment of the present invention.

A feature of the transformer 400 is that a winding region of the magnetic core 10 is divided into two regions having a boundary line in an intermediate position (line Y-Y) along the axial direction (lengthwise direction) of the winding core 10a, and the winding structures in the two regions are different from each other, as shown in FIG. 11.

First, the first and fourth windings 11, 14 are wound in a bifilar winding in the first layer (internal peripheral side), and the third and second winding 13, 12 are wound in a bifilar winding in the second layer (the external peripheral layer) in a region (first winding region) S1 that is half of the winding core 10a. In other words, in this section, the winding pattern is the same as the transformer 100 according to the first embodiment.

On the other hand, the second and third windings 12, 13 are wound in a bifilar winding in the first layer, and the first and fourth windings 11, 14 are wound in a bifilar winding in the second layer in a region (second winding region) S2 that is a remaining half of the winding core 10a. In other words, this section has a winding pattern in which the first and second layers have been exchanged.

In this manner, the inductances of the windings can be matched and a well balanced coupling can also be achieved between the windings because the length of the winding portion of the first and the fourth windings 11, 14 and the length of the winding portion of the second and third windings are substantially the same when the upper and lower winding layers are exchanged at an intermediate position.

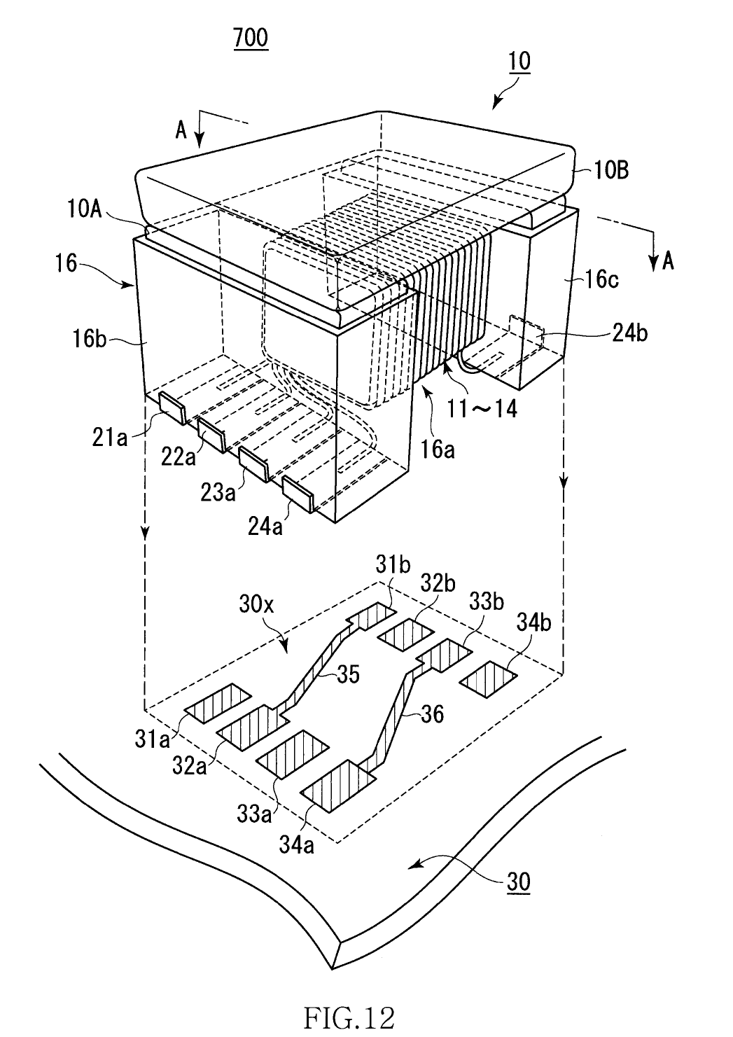

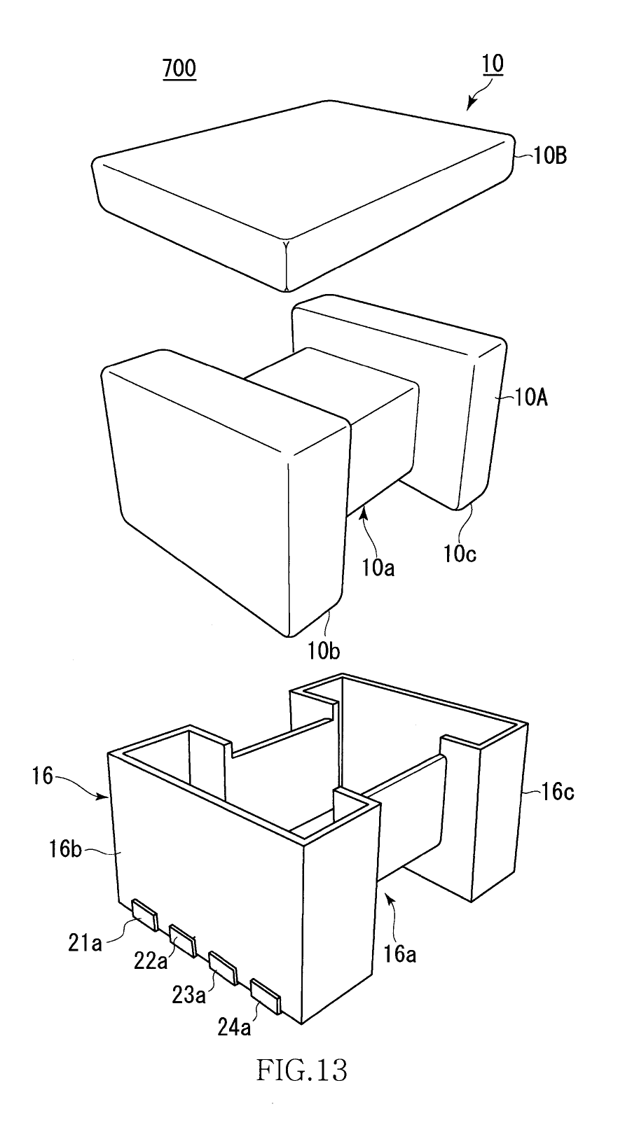

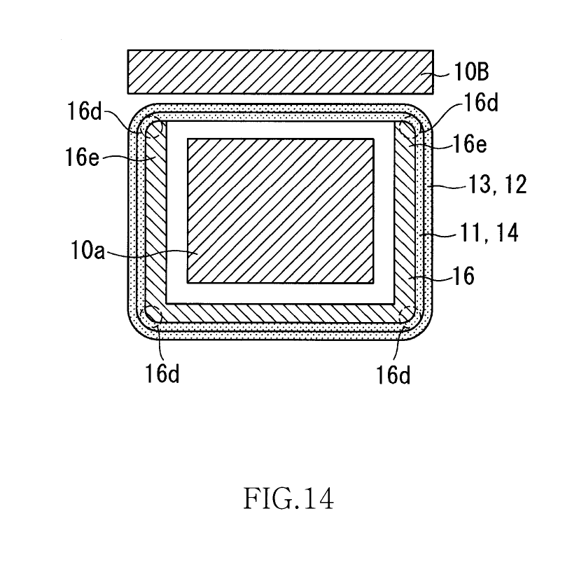

FIG. 12 is a schematic perspective view showing an external appearance of a structure of a transformer 700 according to a fifth embodiment of the present invention. FIG. 13 is an exploded perspective view of the transformer 700. FIG. 14 is a cross-sectional view of the transformer along the line A-A of FIG. 12.

The transformer 700 features a resin cover 16 for accommodating the drum core 10A, as shown in FIGS. 12 and 13. Since other configurations are the same as the transformer 100 according to the first embodiment, the same reference numerals are used for the same constituent elements, and a description thereof is omitted.

The resin cover 16 is made of polyimide or another nonmagnetic insulating resin. The resin cover 16 is provided with the winding core 16a, and flanges 16b, 16c that are provided to the two ends of the winding core. The resin cover 16 is slightly larger than the drum core 10A, and is configured to allow the accommodation of the drum core 10A. FIG. 12 shows the drum core 10A in an accommodated state in the resin cover 16.

Four terminal electrodes 21a through 24a are formed on a lower surface of the flange 16b of the resin cover 16, and four terminal electrodes 21b through 24b (terminal electrodes 21b through 23b are not depicted) are formed on a lower surface of the flange 16c. The drum core 10A and the plate core 10B are made of a sintered Mn—Zn ferrite, as described above, and therefore have high magnetic permeability but a low fixed resistance, and are electroconductive. Therefore, the terminal electrode pairs (21a, 21b) through (24a, 24b) cannot be directly formed on the lower surfaces of the flanges 10b, 10c of the drum core 10A, and paraxylylene or another insulating coating must be applied to the surface of the drum core 10A. However, when the drum core 10A is accommodated in the resin cover 16, there is no need to form the terminal electrode pairs on the drum core 10A, and the terminal electrode pairs can be formed on the bottom surfaces of the flanges 16b, 16c of the resin cover 16. The wire connection state of the terminal electrodes 21a through 24a, 21b through 24b, and the windings 11 through 14 are shown in FIGS. 2 and 3.

A portion of the flanges 10b, 10c is exposed above the resin cover 16 even when the drum core 10A is in an accommodated state, as shown in FIG. 12. This is due to the fact that the height of the flanges 10b, 10c of the drum core 10A is greater than the internal height of the flanges 16b, 16c of the resin cover 16. In contrast, the height of the winding core 10a of the drum core 10 is less than the height of the internal side of winding core 16a of the resin cover 16, and the winding core 10a of the drum core 10A is thereby entirely accommodated in the winding core 16a of the resin cover 16.

It is preferable that the corners 16d of the winding core 16a of the resin cover 16 are chamfered to a rounded state. The windings 11 through 14 are wound on the winding core 16a, and there is a possibility that the windings may be damaged when the corners 16d of the winding core 16a are right angles. Although the corner of the winding core 10a of the drum core 10A may be ground to form rounded surfaces, the rounding of a sintered object made from magnetic material is not easy, and there is a possibility that the corner may be severely damaged. However, the resin cover 16 is composed of resin material, and the rounding of the corner is very easy. The windings are not damaged when the corner 16d of the winding core 16a are rounded. A highly reliable transformer can therefore be realized. The chamfering of the corner 16d is not limited to rounded surfaces, and flat surfaces may also be adopted.

The positional relationship of the first through fourth windings 11 through 14 that are wound on the winding core 16a of the resin cover 16 is shown on FIGS. 4, 8, 10 and 11, and any of the patterns may be used. When the windings 11 through 14 are wound on the winding core 16a of the resin cover 16, the plate-spring properties of a vertical piece 16e of the resin cover 16 will operate on the windings, as shown in FIG. 14. Therefore, it is possible to put the windings into a constant, optimally taut state and to form a state in which the windings are less likely to become displaced by winding the windings with an optimal force.

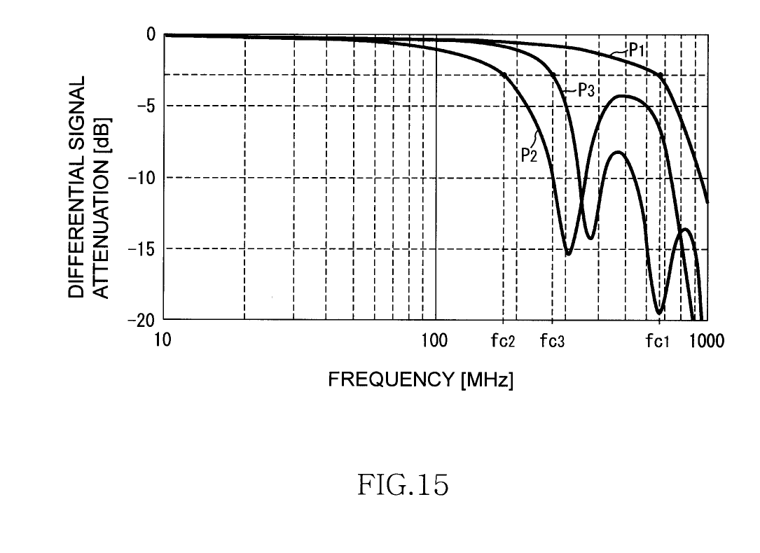

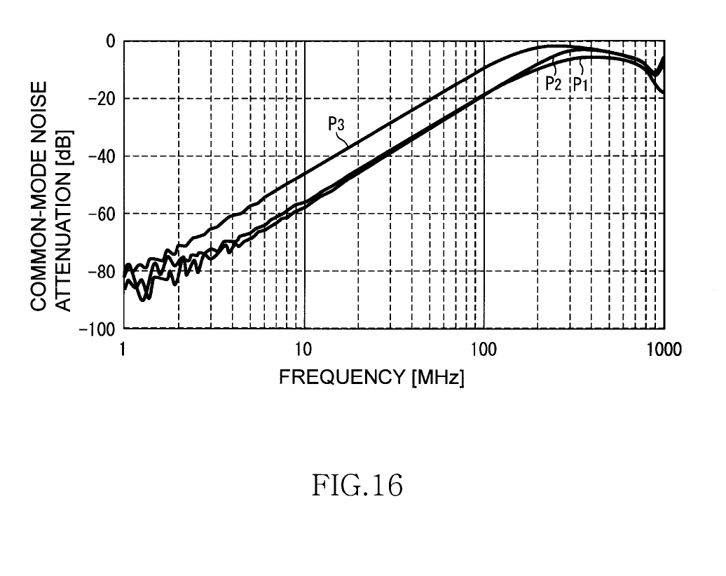

FIG. 15 is a graph showing the insertion loss (signal attenuation characteristics) of the transformer, wherein the frequency (MHz) is shown on the horizontal axis, and the amount of signal attenuation (dB) is shown on the vertical axis. FIG. 16 is a graph showing common-mode noise attenuation characteristics of the transformer, wherein the frequency (MHz) is shown on the horizontal axis, and the amount of noise attenuation (dB) is shown on the vertical axis. In FIGS. 15 and 16, the plotted line P₁ is the measured results from the transformer 100 according to the first embodiment shown in FIG. 4, the plotted line P₂ is the measured results from the transformer 600 according to the reference example shown in FIG. 6, and the plotted line P₃ is the measured results for a case (not depicted) in which the first through fourth windings 11 through 14 are formed as a single-twisted wire.

As shown in FIG. 15, Signal attenuation characteristics of the transformer 100 according to the first embodiment are better than the transformer 600 according to the reference example, and it is apparent that there is little signal attenuation through high-frequency bands. When attention is focused on the cutoff frequency (−3 dB reduction), the cutoff frequency f_{c1} for the line P₁ is approximately 520 MHz, the cutoff frequency f_{c2} for the line P₂ is approximately 181 MHz, and the cutoff frequency f_{c3} for the line P₃ is approximately 270 MHz. In this way, in accordance with the present invention, there is less insertion loss than in a conventional bifilar winding structure (P₂) or stranded wire structure (P₃), and a transformer having little signal attenuation, particularly at high frequencies, can be achieved.

As shown in FIG. 16, it is apparent that common-mode noise attenuation characteristics of the transformer 100 according to the first embodiment show a greater amount of noise attenuation across substantially the entire range of measured frequencies than the transformer 600 according to the reference example. For example, when attention is focused on the amount of noise attenuation at 100 MHz, the amount of noise attenuation for P₁ is −18.2 dB, the amount of noise attenuation for P₂ is −13.4 dB, and the amount of noise attenuation for P₃ is −13.4 dB. In this way, in accordance with the present invention, a transformer having better noise attenuation characteristics than the reference example bifilar winding structure (P₂) or stranded wire structure (P₃) can be achieved.

It is apparent from the aforementioned results that the transformer according to the present invention has the smallest signal attenuation and the greatest noise attenuation.

The present invention was described above on the basis of preferred embodiments thereof, but the present invention is not limited by the abovementioned embodiments, and may be modified in various ways within a range that does not depart from the intended scope of the present invention. It is apparent that such modifications are included in the scope of the present invention.

For example, in the aforementioned embodiments, the first winding 11 and the second winding 12 are connected via the first conductive pattern 35 on the printed circuit board 30, and the third winding 13 and the fourth winding 14 are connected via the second conductive pattern 36, but the present invention is not limited to this type of configuration, and the two windings 11, 12 or the two windings 13, 14 may be connected directly.

In the aforementioned embodiments, a drum core 10A was used as the magnetic core 10, but the present invention is not limited to a drum core, and a toroidal core or another core shape may be used.

In the aforementioned embodiments, the first through fourth windings 11 through 14 were connected in sequence to the terminal electrode pairs 21a, 21b through 24a, 24b, but the connection relationship of the windings with the terminal electrodes is not particularly limited, and connections may be freely made in accordance with the purpose.

What is claimed is:

1. A transformer comprising:
first and second windings that constitute a primary winding;
third and fourth windings that constitute a secondary winding; and
a magnetic core on which the first through fourth windings are wound, wherein
a first distance in a radial direction of a wire between the first winding and the third winding, a second distance in the radial direction of the wire between the first winding and the fourth winding, a third distance in the radial direction of the wire between the second winding and the third winding, and a fourth distance in the radial direction of the wire between the second winding and the fourth winding are substantially equal in the same turn.

2. The transformer as claimed in claim 1, wherein the first winding and the third winding are in contact, the first winding and the fourth winding are in contact, the second winding and the third winding are in contact, and the second winding and the fourth winding are in contact in the same turn.

3. The transformer as claimed in claim 1, wherein a fifth distance in the radial direction of the wire between the first winding and the second winding in the same turn is longer than the first distance in the radial direction of the wire between the first winding and the third winding in the same turn.

4. The transformer as claimed in claim 1, a fifth distance in the radial direction of the wire between the first winding and the second winding in the same turn is substantially equal to a sixth distance in the radial direction of the wire between the third winding and the fourth winding in the same turn.

5. The transformer as claimed in claim 1, wherein the first through fourth windings have the same number of turns, a connecting point between the first winding and the second winding constitute a center point of the primary winding, and a connecting point between the third winding and the fourth winding constitute a center point of the secondary winding.

6. The transformer as claimed in claim 1, further comprising two winding layers including first and second winding layers, wherein
the first winding layer comprises a bifilar winding between the first winding and the fourth winding, and
the second winding layer comprises a bifilar winding between the third winding and the second winding.

7. The transformer as claimed in claim 1, further comprising two winding layers including first and second winding layers, wherein
the first and fourth windings are wound in a bifilar winding in the first winding layer, and the third and second windings are wound in a bifilar winding in the second winding layer in a region that is half of the winding core of the magnetic core, and
the second and third windings are wound in a bifilar winding in the first winding layer, and the fourth and first windings are wound in a bifilar winding in the second winding layer in a region that is a remaining half of the winding core of the magnetic core.

8. The transformer as claimed in claim 1, wherein the magnetic core includes a drum core.

9. The transformer as claimed in claim 8, further comprising a first and a second wiring pattern that is formed on a printed circuit board on which the magnetic core is mounted, wherein the first winding and the second winding are connected via the first wiring pattern on the printed circuit board, and the third winding and the fourth winding are connected via the second wiring pattern on the printed circuit board.

10. The transformer as claimed in claim 8, further comprising a resin cover for accommodating the drum core, wherein the resin cover intervenes between the first through fourth windings and the drum core.

11. The transformer as claimed in claim 10, wherein corners of the resin cover that are in contact with any of the first through fourth windings are chamfered
